(19) United States
(12) Patent Application Publication
(10) Pub. No.: US 2026/0105725 A1
(43) Pub. Date: Apr. 16, 2026

(54) KEYPOINT PREDICTION MODEL TRAINING METHOD, ELECTRONIC DEVICE AND COMPUTER-READABLE STORAGE MEDIUM

(71) Applicant: UBTECH ROBOTICS CORP LTD, Shenzhen (CN)

(72) Inventors: YUSHENG ZENG, Shenzhen (CN); Pei Dong, Shenzhen (CN)

(21) Appl. No.: 19/342,336

(22) Filed: Sep. 26, 2025

(30) Foreign Application Priority Data
Oct. 12, 2024 (CN) 202411427317.3

(51) Int. Cl. G06V 10/77; G06T 7/70; G06V 10/82

(52) U.S. Cl. CPC G06V 10/7715; G06T 7/70; G06V 10/82; G06T 2207/20081; G06T 2207/20084

(57) ABSTRACT

A method includes: obtaining one or more sample keypoints in a sample image and first sample position information of the one or more sample keypoints; extracting a plurality of feature maps of the sample image using a to-be-trained keypoint prediction model; determining first predicted position information of the one or more sample keypoints, and first predicted offset information of one or more target pixel regions where the one or more sample keypoints are located in the plurality of feature maps; determining a model loss value based on the first sample position information, the first predicted position information, first sample offset information of the one or more target pixel regions where the one or more sample keypoints are located, and the first predicted offset information; and updating model parameters of the to-be-trained keypoint prediction model based on the model loss value to obtain a trained keypoint prediction model.

### CROSS REFERENCE TO RELATED APPLICATIONS

This application claims priority to Chinese Patent Application No. CN 202411427317.3, filed Oct. 12, 2024, which is hereby incorporated by reference herein as if set forth in its entirety.

### TECHNICAL FIELD

The present disclosure generally relates to the field of image processing technology, and in particular, relates to a keypoint prediction model training method, electronic device, and computer-readable storage medium.

### BACKGROUND

Keypoint detection is a crucial task in the field of computer vision, widely applied in scenarios such as facial recognition, expression analysis, and image editing.

In related technologies, the main approaches for keypoint detection include determining keypoint locations based on heatmaps and determining keypoint locations based on regression methods. Since heatmap-based methods are relatively slow, regression-based methods are generally used for tasks such as facial recognition and expression analysis. However, regression-based methods for determining keypoint locations suffer from lower accuracy and stability.

Therefore, there is a need to provide a keypoint prediction model training method to overcome the above-mentioned problem.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic diagram of the architecture of a keypoint prediction model training system according to one embodiment.

FIG. 2 is a schematic diagram of the structure of an electronic device according to one embodiment.

FIG. 3 is an exemplary flowchart of a keypoint prediction model training method according to one embodiment.

FIG. 4 is a schematic diagram of the structure of the keypoint prediction model according to one embodiment.

FIG. 5 is an exemplary flowchart of step S104 in FIG. 3 according to one embodiment.

FIG. 6 is an exemplary flowchart of step S1041 in FIG. 5 according to one embodiment.

FIG. 7 is an exemplary flowchart of step S1043 in FIG. 5 according to one embodiment.

FIG. 8 is an exemplary flowchart of step S1044 in FIG. 5 according to one embodiment.

FIG. 9 is another flowchart of a keypoint prediction model training method according to one embodiment.

FIG. 10 is a schematic diagram of the basic model structure of a keypoint prediction model according to one embodiment.

FIG. 11 is a table showing an operational process of the keypoint prediction model.

FIG. 12 is a schematic diagram of multiple feature maps according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

In the embodiments of the present disclosure, the term “module” or “unit” refers to a computer program or portion of a computer program that has a predetermined function and works together with other related components to achieve a predetermined objective. It can be implemented wholly or partly by software, hardware (such as processing circuitry or memory), or a combination thereof. Similarly, a processor (or multiple processors or memory) can be used to implement one or more modules or units. Furthermore, each module or unit can be part of an overall module or unit that incorporates the functionality of that module or unit.

Unless otherwise defined, all technical and scientific terms used in the embodiments of the present disclosure have the same meanings as commonly understood by those skilled in the art. The terms used in the embodiments of the present disclosure are intended solely for the purpose of describing the embodiments of the present disclosure and are not intended to limit the present disclosure.

In the embodiments of the present disclosure, relevant data collection and processing in practical applications should strictly comply with the requirements of relevant laws and regulations and obtain the informed consent or separate consent of the individuals whose personal information is involved. Subsequent data use and processing must be carried out within the scope of the laws and regulations and the authorization of the individuals.

Before further explaining the embodiments of the present disclosure, the terms and terminology used in the embodiments of the present disclosure are explained. The following interpretations apply to the terms and terminology used in the embodiments of the present disclosure.

Keypoints: These are points in an image that serve as identifying role. For example, facial keypoints are used to describe the locations of key features on a face. Facial keypoints include, but are not limited to, the following parts: eyes, nose, mouth, eyebrows, and facial contour.

Keypoint Prediction Model: This is a machine learning model used to predict the locations of keypoints in an image. A keypoint prediction model can take an image as input and output the specific coordinates of keypoints.

Sample Images: These are images with known keypoint annotations used during training or testing. Sample images are used to train and evaluate the performance of keypoint prediction models.

Feature Maps: These are multidimensional arrays extracted from an input image by the convolutional neural network (CNN) in a keypoint prediction model. They reflect local features and structural information in the image.

Pixel Regions: These are local regions within a feature map, typically fixed-size windows or grids.

Sample Keypoints: These are keypoints in sample images used during training to guide the keypoint prediction model in learning the correct keypoint locations.

Sample Location Information: These are the specific coordinates of sample keypoints within a sample image.

Predicted Position Information: This refers to the coordinates of the keypoints predicted by the keypoint prediction model in a sample image.

Sample Offset Information: This refers to the relative position information of the sample keypoints within corresponding target pixel regions, typically expressed as an offset from the top-left corners of the target pixel regions.

Prediction Offset Information: This refers to the relative position information of the keypoints predicted by the keypoint prediction model within corresponding target pixel regions, expressed as an offset from the top-left corners of the target pixel regions.

Mainstream methods for facial keypoint detection mainly include the heatmap-based method and the regression-based method. The heatmap-based method represents the locations of keypoints as a probability map, where the value of each pixel in the map indicates the probability that the location corresponds to a certain keypoint. The location of a keypoint can be determined by finding the pixel with the highest probability. The regression-based method directly predicts the coordinates of keypoints, treating the keypoint locations as continuous values and regressing these coordinates using a keypoint prediction model. The heatmap-based method achieves high keypoint detection accuracy but is relatively slow. However, in practical applications, facial keypoint detection is generally deployed on edge platforms (i.e., computing devices or systems located at the edge of the network). Edge platforms have limited computational power and therefore cannot support keypoint prediction using the heatmap-based method. However, the accuracy and stability of keypoint prediction using the regression-based method are relatively low.

To address the problems existing in related technologies, embodiments of the present disclosure provides a keypoint prediction model training method, apparatus, electronic device, computer-readable storage medium, and computer program product, which can improve the accuracy and stability of keypoint prediction models. The following describes exemplary applications of the electronic device provided in the present disclosure. The electronic device may be implemented as various types of terminals, such as a laptop computer, tablet computer, desktop computer, set-top box, smartphone, smart speaker, smart watch, smart TV, and in-vehicle terminal, and can also be implemented as a server. Below, exemplary applications will be described when the device is implemented as a terminal or as a server.

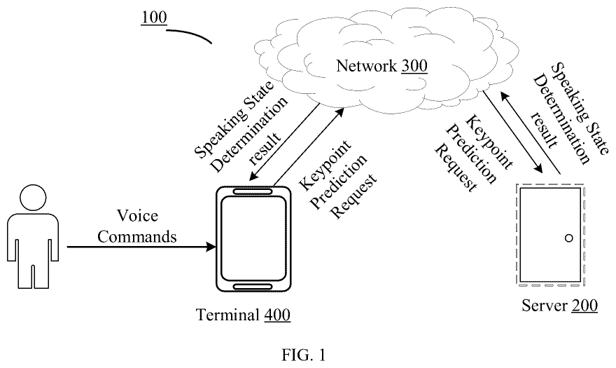

Referring to FIG. 1, which is a schematic diagram of the architecture of a keypoint prediction model training system according to one embodiment. In one embodiment, to support a keypoint prediction model training application, a keypoint prediction model training system 100 may include at least a terminal 400, a network 300, and a server 200. Terminal 400 is connected to server 200 via network 300, which can be a wide area network (WAN), a local area network (LAN), or a combination thereof. For example, in a robot's lip movement speech recognition scenario, a bionic humanoid robot, after receiving a voice command from a target object (e.g., a user), can determine whether the target object is speaking by identifying keypoints on the face. If the target object is speaking, the robot activates the human-computer interaction function to respond to the voice command. If the target object is not speaking, the robot remains in a standby state. Referring to FIG. 1, a user can use terminal 400 to perform interactive operations on the client side of the keypoint prediction model training application. These interactive operations can include, for example, inputting a sample image, clicking to start model training, and the like. After receiving the user's interactive operation, the client sends a keypoint prediction model training request to the server 200 via network 300. After receiving the keypoint prediction model training request, the server 200 responds to the keypoint prediction model training request sent by the terminal and obtains sample keypoints and first sample position information of the sample keypoints in the sample image. The server 200 extracts a number of feature maps of the sample image using a to-be-trained keypoint prediction model. The server 200 determines the first predicted position information of the sample keypoints and the first predicted offset information of the target pixel regions where the sample keypoints are located in the feature maps. The server 200 determines a model loss value based on the first sample position information, the first predicted position information, the first sample offset information of the sample keypoints in the target pixel regions, and the first predicted offset information. Based on the model loss value, the server 200 updates the model parameters of the to-be-trained keypoint prediction model, thereby obtaining a trained keypoint prediction model.

After the keypoint prediction model is trained, the user can issue a voice command. Upon receiving the voice command, the robot's terminal 400 captures one or more facial images of the user, packages the one or more facial images into a keypoint prediction request, and sends the keypoint prediction request to the server 200 via the network 300. In response to the keypoint prediction request, the server 200 processes the one or more facial images based on the keypoint prediction model to obtain the facial keypoints. Based on the facial keypoints, the server 200 determines the user's speaking state determination result. The server 200 can send the speaking state determination result to the terminal 400. If the speaking state determination result indicates that the user is speaking, the terminal 400 wakes up and responds to the voice command. If the speaking state determination result indicates that the user is not speaking, the terminal 400 remains in a standby state.

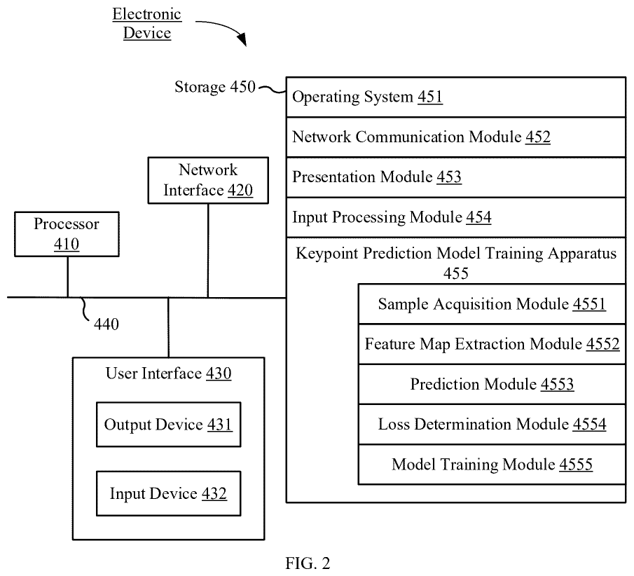

Referring to FIG. 2, which is a schematic diagram of the structure of an electronic device according to one embodiment. The electronic device shown in FIG. 2 includes at least one processor 410, a storage 450, at least one network interface 420, and a user interface 430. The various components in the terminal 400 are coupled together via a bus system 440. It will be understood that the bus system 440 is used to implement connection and communication between these components. In addition to a data bus, the bus system 440 further includes a power bus, a control bus, and a status signal bus. However, for the sake of clarity, in FIG. 2, all various buses are collectively labeled as the bus system 440.

Processor 410 can be an integrated circuit chip with signal processing capabilities, such as a general-purpose processor, a digital signal processor (DSP), or other programmable logic device, discrete gate or transistor logic device, discrete hardware components, and the like. A general-purpose processor can be a microprocessor or any conventional processor.

User interface 430 includes one or more output devices 431 that enable the presentation of media content, including one or more speakers and/or one or more visual displays. User interface 430 further includes one or more input devices 432, including user interface components that facilitate user input, such as a keyboard, mouse, microphone, touchscreen display, camera, and other input buttons and controls.

Storage 450 can be removable, non-removable, or a combination thereof.

Exemplary hardware devices include solid-state memory, a hard drive, and an optical drive. Storage 450 may optionally include one or more storage devices physically remote from processor 410.

Storage 450 may include volatile memory, non-volatile memory, or a combination thereof. Non-volatile memory can be read-only memory (ROM), and volatile memory can be random access memory (RAM). The storage 450 described in the embodiments of the present disclosure is intended to include any suitable type of memory.

In some embodiments, storage 450 can store data to support various operations. Examples of this data include programs, modules, and data structures, or subsets or supersets thereof, as exemplified below.

The operating system 451 includes system programs for handling various basic system services and performing hardware-related tasks, such as a framework layer, a core library layer, and a driver layer, which implement various fundamental services and handle hardware-based tasks.

The network communication module 452 is used to connect to other electronic devices via one or more (wired or wireless) network interfaces 420. Exemplary network interfaces 420 include Bluetooth, Wi-Fi, and Universal Serial Bus (USB).

The presentation module 453 enables information presentation (e.g., a user interface for operating peripheral devices and displaying content and information) via one or more output devices 431 (e.g., a display screen, speakers, etc.) associated with the user interface 430.

The input processing module 454 is used to detect one or more user inputs or interactions from one or more input devices 432 and interpret the detected inputs or interactions.

In some embodiments, the apparatus provided in the embodiments of the present disclosure can be implemented in software. FIG. 2 shows a keypoint prediction model training apparatus 455 stored in storage 450. The apparatus 455 can be software in the form of a program or plug-in, and includes the following software modules: a sample acquisition module 4551, a feature map extraction module 4552, a prediction module 4553, a loss determination module 4554, and a model training module 4555. These modules are logical and can be arbitrarily combined or further divided according to the functions implemented. The functions of each module will be described below.

In other embodiments, the apparatus may be implemented in hardware. As an example, the apparatus may be a processor in the form of a hardware decoding processor, which is programmed to execute the keypoint prediction model training method provided in the embodiments of the present disclosure. For example, the processor in the form of a hardware decoding processor may be one or more application-specific integrated circuits (ASICs), digital signal processors (DSPs), programmable logic devices (PLDs), complex programmable logic devices (CPLDs), field-programmable gate arrays (FPGAs), or other electronic components.

The keypoint prediction model training method provided in the embodiments of the present disclosure will be described in conjunction with an exemplary application and implementation of the server provided in the embodiments of the present disclosure.

The following describes the keypoint prediction model training method provided in the embodiments of the present disclosure. As previously mentioned, the electronic device implementing the keypoint prediction model training method in the embodiments of the present disclosure can be a terminal, a server, or a combination of thereof. Therefore, the execution subjects of the respective steps will not be described in detail again below.

It should be noted that in the examples of keypoint prediction model training described below, the scenario of facial recognition is used as an example, in which the image is a facial image. Based on their understanding of the following, those skilled in the art can apply the keypoint prediction model training method provided in the embodiments of the present disclosure to other scenarios, such as pose estimation, medical image analysis, autonomous driving, gesture recognition, and the like.

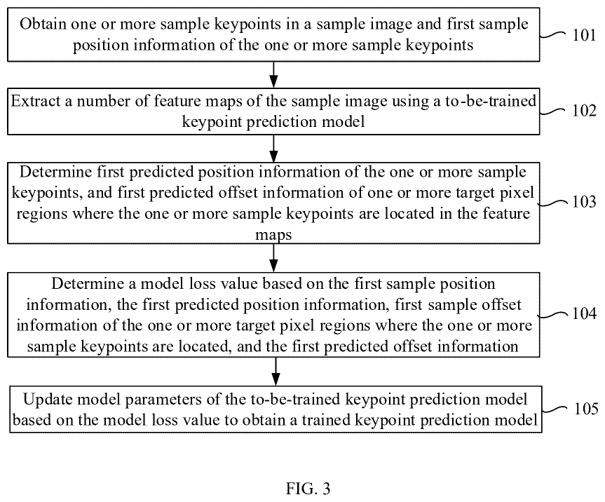

FIG. 3 is a flowchart of a keypoint prediction model training method according to one embodiment. The method will be described in conjunction with the steps shown in FIG. 3. As shown in FIG. 3, the method is described by taking the execution subject of the keypoint prediction model training method as a server as an example. The method may include the following steps 101 to 105.

Step S101: Obtain one or more sample keypoints in a sample image and first sample position information of the one or more sample keypoints.

Here, the sample image is an image annotated with one or more known sample keypoints. Sample keypoints are points used to describe the location of key features in the sample image. The first sample position information refers to the coordinates of the sample keypoints in the sample image. For example, the sample image is a facial image with an image size of 112×112 pixels, that is, the width and height are both 112 pixels, and there are 98 sample keypoints in the sample image. Each sample keypoint is marked with a circle in the sample image and is accompanied by coordinates. The first sample position information of a sample keypoint can be, for instance, the coordinates (10, 10). The 98 sample keypoints include, but are not limited to, the center of the left eye, the center of the right eye, the tip of the nose, the left corner of the mouth, and the right corner of the mouth.

Step S102: Extract a number of feature maps of the sample image using a to-be-trained keypoint prediction model.

In one embodiment, a single sample image is used. In another embodiment, multiple sample images are used. The to-be-trained keypoint prediction model is a machine learning model used to predict the locations of keypoints in an image. The specific model structure of the keypoint prediction model is not limited in the embodiments of the present disclosure. When a sample image is input into the to-be-trained keypoint prediction model, the convolutional layer in the keypoint prediction model will convolve the sample image to obtain a number of feature maps.

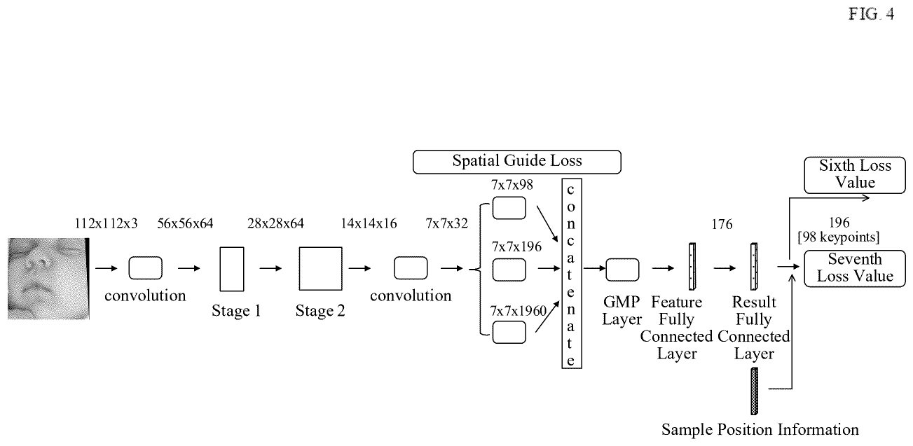

FIG. 4 is a schematic diagram of the structure of the keypoint prediction model according to one embodiment. Referring to FIG. 4, the keypoint prediction model may include multiple convolutional layers, a global group max pooling (GMP) layer, a feature fully connected layer (fea_fc), and a result fully connected layer (res_fc). The sample image is a 112×112×3 facial image, where 112×112 represents the width and height, and 3 represents the number of channels. The sample image is processed through multiple convolution operations to obtain an initial feature map of 7×7×32, which is then further convolved to obtain a feature map of 7×7×98. The initial feature map of 7×7×32 includes 32 features maps, each of size 7×7, and the feature map of 7×7×98 includes 98 features maps, each of size 7×7.

Step S103: Determine first predicted position information of the one or more sample keypoints, and first predicted offset information of one or more target pixel regions where the one or more sample keypoints are located in the feature maps.

Here, the keypoint prediction model can be used to output the first predicted position information for each sample keypoint in the sample image. The first predicted position information is the coordinates of the sample keypoints on the sample image predicted by the keypoint prediction model. The first predicted position information and the first sample position information of the sample keypoint may be the same or different. For example, the sample image is a facial image with an image size of 112×112 pixels and 98 sample keypoints. The first sample position information of a first sample keypoint A is (10, 10), and the first predicted position information is (6, 8).

Each feature map includes multiple pixel regions, which are divided based on the width and height of the feature map. For example, if the size of the feature map is 7×7×98, the feature map can be divided into 7 rows and 7 columns, that is, 49 pixel regions. 98 is the number of channels, and each channel is used to predict a sample keypoint. For each sample keypoint, the target pixel region where the sample keypoint is located can be determined based on the first sample position information of the sample keypoint. Specifically, since the original sample image size is 112×112, each pixel region in the feature map includes 16 pixels. Assuming that the coordinates of the upper left corner of the sample image are (0, 0), the coordinates of the upper left corner of the pixel region in the first row and first column of the feature map are (0, 0), and the coordinates of the lower right corner are (16, 16). If the first sample position information of sample keypoint A is (10, 10), then the target pixel region of sample keypoint A is the pixel region in the first row and first column.

The first prediction offset information may be the relative offset between the first predicted position information of the sample keypoint and the upper left corner of the target pixel region. The first prediction offset information includes a relative prediction offset in a first direction and a relative prediction offset in a second direction. The first direction may be the x-axis direction in the coordinate system, and the second direction may be the y-axis direction in the coordinate system. For example, assuming that the first prediction offset information of the sample keypoint A in the target pixel region includes a relative prediction offset of 0.4 in the x-axis direction and a relative prediction offset of 0.5 in the y-axis direction, since there are 16 pixels in a pixel region, 16×0.4-6.4, and the sample keypoint A is offset to the right by 6 coordinate points from the upper left corner of the target pixel region; and 16×0.5-8, and the sample keypoint A is offset downward by 8 coordinate points from the upper left corner of the target pixel region, the first predicted position information of the sample keypoint A may be (6, 8).

As shown in FIG. 4, the keypoint prediction model convolves the 7×7×32 initial feature map to obtain a 7×7×196 offset feature map. The 196 channels are used to predict the first predicted offset information of the 98 sample keypoints in the first and second directions.

Step S104: Determine a model loss value based on the first sample position information, the first predicted position information, first sample offset information of the one or more target pixel regions where the one or more sample keypoints are located, and the first predicted offset information.

Here, the first sample offset information can be the relative offset between the first sample position information of the sample keypoint and the upper left corner of the target pixel region. The first sample offset information includes the relative sample offset in the first direction and the relative sample offset in the second direction. The method for determining the first sample offset information can refer to the method for determining the first prediction offset information in step S103, and will not be repeated here. The model loss value is a quantitative indicator for measuring the difference between the prediction result of the keypoint prediction model and the true label of the sample keypoint. Based on the first sample position information and the first predicted position information of multiple sample keypoints, and the first sample offset information and the first prediction offset information of multiple sample keypoints in the target pixel region, multiple loss values can be determined, and the multiple loss values are fused to obtain the model loss value.

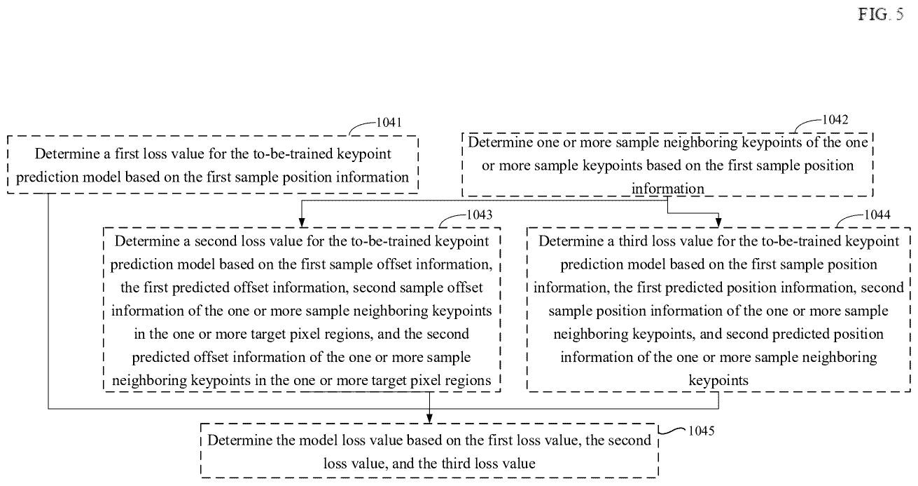

In some embodiments, referring to FIG. 5, step S104 may be implemented by following steps S1041 to S1045, which are described in detail below.

Step S1041: Determine a first loss value for the to-be-trained keypoint prediction model based on the first sample position information.

Here, the first loss value is a quantitative indicator that measures the prediction accuracy of the keypoint prediction model by comparing the difference between the first prediction score of the sample keypoint predicted by the keypoint prediction model with respect to each pixel region of the feature map and the first label score of the sample keypoint. The first prediction score is the probability, predicted by the keypoint prediction model, that the sample keypoint is located within a pixel region. The first label score includes two values: 0 and 1. When the first label score is 0, the true coordinates of the sample keypoint are not located in the pixel region. When the first label score is 1, the true coordinates of the sample keypoint are located in the pixel region. Therefore, the first loss value is a quantitative indicator that measures the prediction accuracy of the keypoint prediction model by comparing the difference between the prediction probability of the sample keypoint predicted by the keypoint prediction model with respect to each pixel region of the feature map and the true label of the sample keypoint. The first label score of the sample keypoint can be determined based on the first sample position information of the sample keypoint. The first loss value is determined based on the first label score and the first prediction score of each sample keypoint located in each pixel region.

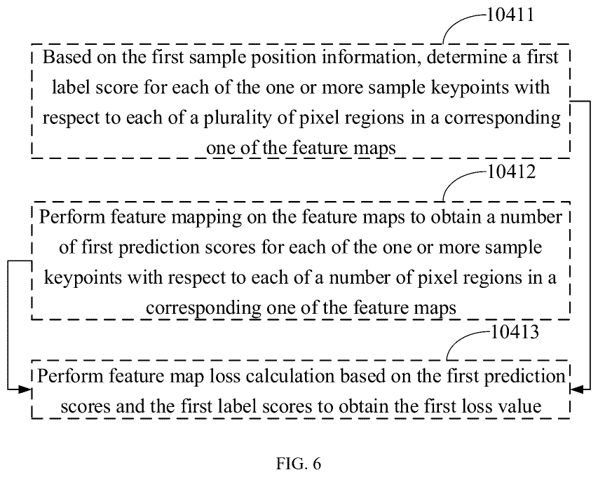

In some embodiments, referring to FIG. 6, step S1041 may be implemented by following steps S10411 to S10413, which are described in detail below.

Step S10411: Based on the first sample position information, determine a first label score for each of the one or more sample keypoints with respect to each of a plurality of pixel regions in a corresponding one of the feature maps.

Here, the first label score is to identify whether the sample keypoint is actually located in a pixel region. For each sample keypoint, the target pixel region where the sample keypoint is located can be determined based on the first sample position information of the sample keypoint. The first label score of the sample keypoint located in the target pixel region is set to “1”, and the first label score of the sample keypoint located in the remaining pixel regions in the feature map is set to “0”.

In some embodiments, step 10411 can be achieved in the following manner: when the sample keypoint is determined to be located within a pixel region according to the first sample position information, determining the first label score to be a first preset score; or, when the sample keypoint is determined to be located outside the pixel region according to the first sample position information, determining the first label score to be a second preset score.

Exemplarily, the first preset score is a value of 1, and the second preset score is a value of 0. The first sample position information of the sample keypoint A is (10, 10). For the pixel region in the first row and first column of the feature map, the true coordinates (10, 10) of the sample keypoint A fall within the pixel region, and the sample keypoint A is determined to be located within the pixel region, and the first label score of the sample keypoint A in the pixel region is 1. For the pixel region in the first row and second column, the true coordinates (10, 10) of the sample keypoint A do not fall within the pixel region, and the sample keypoint A is determined to be outside the pixel region, and the first label score of the sample keypoint A in the pixel region is 0.

Step S10412: Perform feature mapping on the feature maps to obtain a number of first prediction scores for each of the one or more sample keypoints with respect to each of a number of pixel regions in a corresponding one of the feature maps.

For example, the keypoint prediction model performs feature mapping on a 7×7×98 feature map to obtain the predicted probability of each of the 98 sample keypoints being located in each of the 49 pixel regions, and determines the predicted probabilities as the first prediction scores. The feature mapping process may be a convolution process. For sample keypoint A, the first prediction score for sample keypoint A located in the pixel region of row 1 and column 1 is 0.95, and the first prediction score for sample keypoint A located in the pixel region of row 1 and column 2 is 0.03.

Step S10413: Perform feature map loss calculation based on the first prediction scores and the first label scores to obtain the first loss value.

Here, a loss function (such as cross entropy loss or mean square error) can be used to calculate the difference between the first prediction scores and the first label scores to obtain a first loss value. For example, for each sample keypoint and each pixel region, the score difference between the first label score and the first prediction score for the sample keypoint with respect to the pixel region is determined, and the score difference is squared to obtain a square value. The first loss value can be determined based on the sum of the square values of each sample keypoint with respect to each pixel region and the size information of the feature map. The first loss value can be calculated according to the following equation (1):

$${L}_{s} = \frac{1}{98 * 7 * 7} {\sum }_{i = 1}^{98} {\sum }_{j = 1}^{7} {\sum }_{k}^{7} {( {s}_{ijk}^{gt} - {s}_{ijk}^{pred} )}^{2} ,$$

where Lₛ is the first loss value, i is the number of channels of the feature map, j is the height of the feature map, k is the width of the feature map,

$${s}_{ijk}^{gt}$$

is the first label score of the i-th sample keypoint with respect to the j-th row and k-th column pixel region,

$${s}_{ijk}^{pred}$$

is the first prediction score of the i-th sample keypoint with respect to the j-th row and k-th column pixel region.

By mapping the actual positions of sample keypoints to pixel regions in the feature maps and assigning first label scores to these pixel regions, it is possible to clearly indicate which pixel regions contain real sample keypoints. By performing feature mapping processing on the feature maps, a first prediction scores are generated, which quantifies the possibility that each pixel region contains a sample keypoint. By calculating the difference between the first prediction scores and the first label scores, a first loss value is obtained, which can quantify the prediction error of the keypoint prediction model, help evaluate the prediction performance of the keypoint prediction model on the feature maps, and guide subsequent parameter updates, thereby improving the overall prediction accuracy of the keypoint prediction model.

Referring to FIG. 5 again, the description proceeds from step 1041 mentioned above.

Step S1042: Determine one or more sample neighboring keypoints of the one or more sample keypoints based on the first sample position information.

Here, for each sample keypoint, a sample neighboring keypoint of the sample keypoint refers to the sample keypoint that is closest to the sample keypoint. The number of sample neighboring keypoints of a sample keypoint can be one or more. A sample distances between the sample keypoint and each of the other sample keypoints can be determined based on the first sample position information of the sample keypoint and the first sample position information of each of the other sample keypoints. At least one sample keypoint whose sample distance is less than or equal to a preset distance threshold is determined as the sample neighboring keypoint of the sample keypoint. Alternatively, multiple other sample keypoints can be sorted in ascending order of sample distance, and the first N sample keypoints are selected as the sample neighboring keypoints of the sample keypoint, where N is a positive integer. For example, for sample keypoint A among the 98 sample keypoints in the sample image, the sample distances between sample keypoint A and the other 97 sample keypoints are calculated. The 10 sample keypoints with the smallest sample distances are selected from the 97 sample keypoints as the 10 sample neighboring keypoints of sample keypoint A.

Step S1043: Determine a second loss value for the to-be-trained keypoint prediction model based on the first sample offset information, the first predicted offset information, second sample offset information of the one or more sample neighboring keypoints in the one or more target pixel regions, and the second predicted offset information of the one or more sample neighboring keypoints in the one or more target pixel regions.

Here, the second loss value is an indicator that measures the prediction accuracy of the keypoint prediction model by quantifying the error of the keypoint prediction model in the keypoint offset prediction. Specifically, the second loss value combines the offset information of the sample keypoint and the sample neighboring keypoints of the sample keypoint in the feature map, so as to more comprehensively evaluate the prediction performance of the keypoint prediction model. The second sample offset information and the second predicted offset information of the sample neighboring keypoints in the target pixel region can refer to the first sample offset information and the first predicted offset information of the sample keypoint in the target pixel region in the other embodiments mentioned above, and will not be repeated here. Referring to FIG. 4, the keypoint prediction model can obtain a 7×7×1960 neighboring offset feature map by convolving the initial feature map of 7×7×32. Each of the 98 sample keypoints has 10 sample neighboring keypoints, and 1960 channels are used to predict the second predicted offset information of the 980 sample neighboring keypoints in the first direction and the second direction.

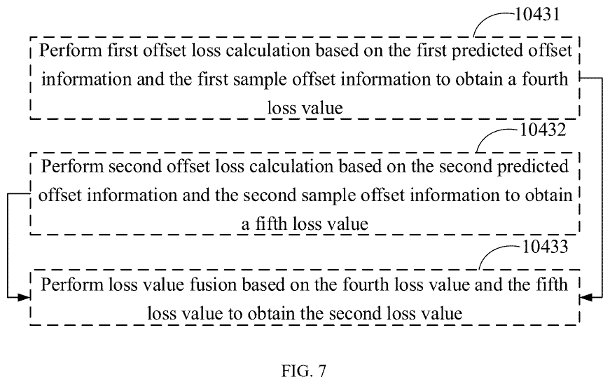

In some embodiments, referring to FIG. 7, step S1043 may be implemented by following steps S10431 to S10433, which are described in detail below.

Step S10431: Perform first offset loss calculation based on the first predicted offset information and the first sample offset information to obtain a fourth loss value.

Here, the fourth loss value is an indicator that measures the difference between the first predicted offset information of the sample keypoint predicted by the keypoint prediction model and the actual first sample offset information of the sample keypoint. The difference between the first predicted offset information and the first sample offset information can be calculated using a loss function (such as cross entropy loss or mean square error) to obtain the fourth loss value. Exemplarily, for each sample keypoint, a first offset difference between the first sample offset information and the first predicted offset information of the sample keypoint in the target pixel region in the first direction, and a second offset difference between the first sample offset information and the first predicted offset information in the second direction are determined, and the fourth loss value is determined based on the sum of the first offset differences and the second offset differences. The fourth loss value can be calculated according to the following equation (2):

$${L}_{self - off} = \frac{1}{196} {\sum }_{D = 1}^{2} \vert {o}_{ijkD}^{gt} - {o}_{ijkD}^{pred} \vert where$$

$${s}_{ijk}^{gt} = 1 ,$$

where L_{self-off} is the fourth loss value, D=1 represents the first direction (i.e., x-axis direction), D=2 represents the second direction (i.e., y-axis direction),

$${o}_{ijkD}^{pred}$$

is the first prediction offset information in the x-axis or y-axis direction,

$${o}_{ijkD}^{gt}$$

is the first sample onset information in the x-axis or y-axis direction, where

$${s}_{ijk}^{gt}$$

means that the first label score of the pixel region in the j-row and j-column of the i-th sample keypoint is 1, that is, the pixel region in the j-row and j-column is the target pixel region of the i-th sample keypoint.

Step S10432: Perform second offset loss calculation based on the second predicted offset information and the second sample offset information to obtain a fifth loss value.

Here, the fifth loss value is an indicator that measures the difference between the second predicted offset information of the sample neighboring keypoints predicted by the keypoint prediction model and the actual second sample offset information of the sample neighboring keypoint. The difference between the second predicted offset information and the second sample offset information can be calculated using a loss function (such as cross entropy loss or mean square error) to obtain the fifth loss value. Exemplarily, for each sample keypoint, the third offset difference between the second sample offset information and the second predicted offset information in the first direction of each sample neighboring keypoint of the sample keypoint in the target pixel region, as well as the fourth offset difference between the second sample offset information and the second predicted offset information in the second direction, are determined, and the fifth loss value is determined based on the sum of the third offset difference and the fourth offset difference. The fifth loss value can be calculated according to the following equation (3):

$${L}_{n - off} = \frac{1}{1960} {\sum }_{H = 1}^{20} \vert {n}_{ijkH}^{gt} - {n}_{ijkH}^{pred} \vert$$

$$where {s}_{ijk}^{gt} = 1 ,$$

where L_{n-off} is the fifth loss value, H is the first direction and the second direction of the 10 sample neighboring keypoints,

$${n}_{ijkH}^{pred}$$

is the second predicted offset information of the H-th sample neighboring keypoint of the i-th sample keypoint in the x-axis or y-axis direction, and

$${n}_{ijkH}^{gt}$$

is the second sample offset information of the H-th sample neighboring keypoint of the i-th sample keypoint in the x-axis or y-axis direction.

Step S10433: Perform loss value fusion based on the fourth loss value and the fifth loss value to obtain the second loss value.

Here, the fourth and fifth loss values can be weighted and summed based on the preset first weight parameter corresponding to the fourth loss value and the second weight parameter corresponding to the fifth loss value to obtain the second loss value. In the embodiments of the present disclosure, the specific values of the first weight parameter and the second weight parameter are not limited and may be set as desired.

By calculating the fourth loss value, which reflects the offset error of the sample keypoint, and the fifth loss value, which reflects the offset error of the sample neighboring keypoints, and fusing them together to obtain the second loss value, the accuracy of the keypoint prediction model in predicting the offsets of keypoints and their neighboring keypoints can be more comprehensively evaluated and optimized, thereby improving the accuracy and stability of the trained keypoint prediction model.

Referring to FIG. 5 again, the description proceeds from step 1043 mentioned above.

Step S1044: Determine a third loss value for the to-be-trained keypoint prediction model based on the first sample position information, the first predicted position information, second sample position information of the one or more sample neighboring keypoints, and second predicted position information of the one or more sample neighboring keypoints.

Here, the third loss value is an indicator that combines the predicted distance error and position error between the sample keypoint and its neighboring keypoints.

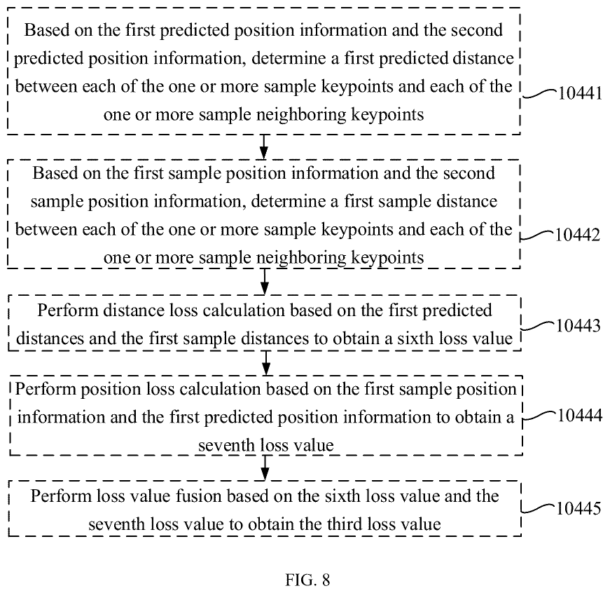

In some embodiments, referring to FIG. 8, step S1044 can be implemented by following the steps S10441 to S10445, which are described in detail below.

Step S10441: Based on the first predicted position information and the second predicted position information, determine a first predicted distance between each of the one or more sample keypoints and each of the one or more sample neighboring keypoints.

Here, for each sample keypoint, a first predicted distance between the sample keypoint and each of the sample neighboring keypoints can be calculated based on the first predicted position information of the sample keypoint and the second predicted position information of the sample keypoint's multiple sample neighboring keypoints. The embodiments of the present disclosure do not place any limitation on the specific calculation formula of the first predicted distance. Since the first predicted position information and the second predicted position information are both coordinates, a method for calculating distance using coordinates can be used.

Step S10442: Based on the first sample position information and the second sample position information, determine a first sample distance between each of the one or more sample keypoints and each of the one or more sample neighboring keypoints.

Here, for each sample keypoint, the first sample distance between the sample keypoint and each sample neighboring keypoint can be calculated based on the first sample position information of the sample keypoint and the second sample position information of multiple sample neighboring keypoints of the sample keypoint.

Step S10443: Perform distance loss calculation based on the first predicted distances and the first sample distances to obtain a sixth loss value.

Here, the sixth loss value is an indicator used to measure the error between the distance between the sample keypoint and each of the sample neighboring keypoints predicted by the keypoint prediction model and the actual distance between the sample keypoint and each of the sample neighboring keypoints. The sixth loss value can be obtained by calculating the difference between the first predicted distance and the first sample distance using a loss function (such as cross entropy loss or mean square error). Exemplarily, for each sample keypoint, the distance difference between the first sample distance and the first predicted distance between the sample keypoint and each sample neighboring keypoint is determined, and the sixth loss value is determined based on the sum of multiple distance differences. The sixth loss value can be calculated according to the following equation (4):

$${L}_{n b} = \frac{1}{98} {\sum }_{i = 1}^{98} {\sum }_{n = 1}^{10} ‖ {Dist}^{g t} ( {P}_{i} - {P}_{i \_ n} ) - {Dist}^{pred} ( {P}_{i} - {P}_{i \_ n} ) ‖ ,$$

where L_{nb} is the sixth loss value, Pᵢ is the i-th sample keypoint, P_{i_n} is the n-th sample neighboring keypoint of the i-th sample keypoint, Dist^{gt}(Pᵢ−P_{i_n}) is the first sample distance between the i-th sample keypoint and the n-th sample neighboring keypoint of the i-th sample keypoint, Dist^{pred}(Pᵢ−P_{i_n}) is the first predicted distance between the i-th sample keypoint and the n-th sample neighboring keypoint of the i-th sample keypoint.

Step S10444: Perform position loss calculation based on the first sample position information and the first predicted position information to obtain a seventh loss value.

Here, the seventh loss value is an indicator that measures the difference between the keypoint position predicted by the keypoint prediction model and the actual keypoint position. A loss function can be used to calculate the difference between the first sample position information and the first predicted position information to obtain the seventh loss value. The embodiments of the present disclosure does not specifically limit the loss function used to calculate the seventh loss value. For example, loss functions such as L1 loss and L2 loss can be used. For example, in one embodiment, a regression loss function (wing loss) can be used to calculate the seventh loss value.

In one embodiment, step S10444 may be implemented as follows: First, the position information error between the first sample position information and the first predicted position information is determined. Then, if the position information error is less than a preset position error, a first parameter is determined based on a preset parameter and the position information error, and the product of the preset position error and the first parameter is determined as the seventh loss value for the sample keypoint. Alternatively, if the position information error is greater than or equal to the preset position error, a second parameter is determined based on the preset parameter and the position information error, and the product of the preset position error and the second parameter is determined; the difference between the preset position error and the product is determined as the first difference; and the second difference between the position error and the first difference is determined as the seventh loss value.

It should be noted that in the embodiments of the present disclosure, the values of the preset position error and the preset parameter are not limited and may be set according to actual circumstances. For example, the preset position error may be 10, and the preset parameter may be 2. The calculation equations for the first parameter and the second parameter can be the same or different. The position information error between the first sample position information and the first predicted position information is calculated separately in the first direction and the second direction. The difference between the first sample position information and the first predicted position information can be used as the position information error. That is, for the sample keypoint A, the first sample position information of the sample keypoint A is (10, 10), and the first predicted position information is (6, 8), then the position information error of the sample keypoint A in the first direction is 10−6=4, and the position information error in the second direction is 10−8=2.

The seventh loss value can be calculated according to the equations (5) and (6) as follows:

$$wing ( x ) = \{ \begin{matrix}ω ln ( 1 + \frac{\vert x \vert}{ϵ} ) & if \vert x \vert < ω \\ \vert x \vert - C & others\end{matrix} and$$

$$C = ω - ω ln ( 1 + \frac{\vert x \vert}{ϵ} ) ,$$

where wing(x) is the seventh loss value, ω is the preset position error, |x| is the position information error, ∈ is the preset parameter,

$$ln ( 1 + \frac{\vert x \vert}{ϵ} )$$

is the first parameter or the second parameter, and C is the first difference.

Step S10445: Perform loss value fusion based on the sixth loss value and the seventh loss value to obtain the third loss value.

Here, the sixth and seventh loss values are weighted and summed based on a preset weight parameter to obtain a third loss value.

By calculating the difference between the first predicted distance and the first sample distance and combining it with the keypoint location loss, the third loss value is obtained. This allows for a more comprehensive assessment of the keypoint prediction model's accuracy in predicting the locations of keypoints and their neighboring keypoints, thereby improving the model's overall performance.

Referring to FIG. 5 again, the description proceeds from step 1044 mentioned above.

Step S1045: Determine the model loss value based on the first loss value, the second loss value, and the third loss value.

Here, the model loss value can be determined as the sum of the first, second, and third loss values. Alternatively, the model loss value can be obtained by weightedly summing the first, second, and third loss values based on a preset weight parameter.

By comprehensively considering the position and offset differences of sample keypoints, the offset differences of sample neighboring keypoints, and the distance differences between each sample keypoint and its neighboring keypoints, the model loss value can be used to comprehensively evaluate and optimize the keypoint prediction model's accuracy, thereby improving overall performance.

Referring to FIG. 3 again, the description proceeds from step 104 mentioned above.

Step S105: Update model parameters of the to-be-trained keypoint prediction model based on the model loss value to obtain a trained keypoint prediction model.

Here, a backpropagation algorithm can be used to calculate the gradient of the model loss value with respect to the model parameters in the to-be-trained keypoint prediction model, and an optimization algorithm (such as stochastic gradient descent) can be used to update the model parameters. Using the keypoint prediction model with updated model parameters, steps S102-S105 are repeated until the model loss value reaches a minimum value or a preset number of training epochs is reached, thereby obtaining a trained keypoint prediction model.

During the training of the keypoint prediction model, the actual first sample position information of each sample keypoint and the first sample offset information of the sample keypoint in the target pixel region of a corresponding feature map are determined, along with the first predicted offset information of the sample keypoint and the first predicted position information of the sample keypoint in the target pixel region of the feature map as predicted by the keypoint prediction model. By using the first sample position information, the first predicted position information, the first sample offset information, and the first predicted offset information, a more accurate model loss value can be calculated. The keypoint prediction model can then be trained with this model loss value, thereby improving the detection accuracy and stability of the keypoint prediction model.

Referring to FIG. 4, after training, the keypoint prediction model can be used to predict keypoints in facial images. It performs convolution processing on a facial image to produce a first feature map of 7×7×98, a second feature map of 7×7×196, and a third feature map of 7×7×1980. The first, second, and third feature maps are concatenated to form a target feature map. This target feature map is then pooled and mapped using a fully connected layer to obtain the coordinates of the 98 keypoints.

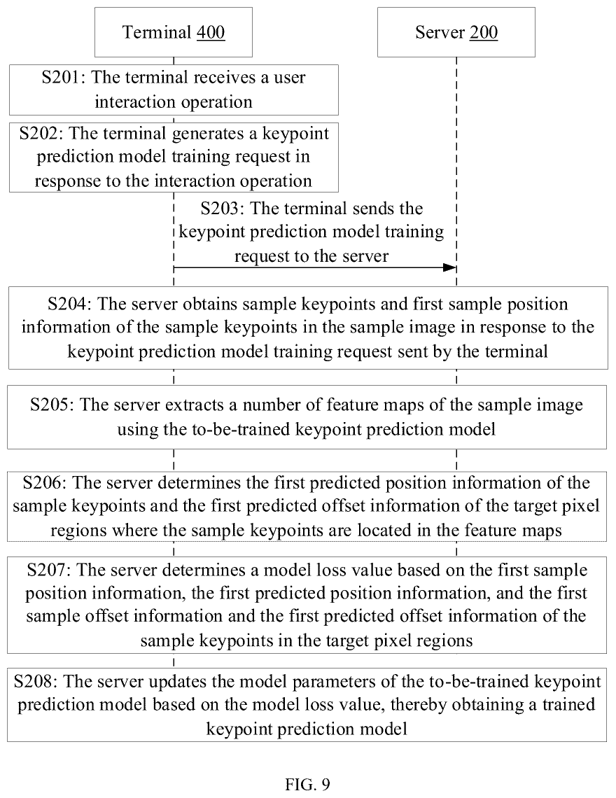

FIG. 9 is another flowchart of a keypoint prediction model training method according to one embodiment. As shown in FIG. 9, the method includes the following steps 201 to 208.

Step S201: The terminal receives a user interaction operation.

Here, the interaction operation may be clicking to input a sample image, clicking to start model training, or the like.

Step 202: The terminal generates a keypoint prediction model training request in response to the interaction operation.

Step 203: The terminal sends the keypoint prediction model training request to the server.

Step 204: The server obtains sample keypoints and first sample position information of the sample keypoints in the sample image in response to the keypoint prediction model training request sent by the terminal.

Here, the specific process of obtaining the sample keypoints and first sample position information of the sample keypoints in the sample image can be referred to as step S101 in the above embodiment and will not be repeated here.

Step 205: The server extracts a number of feature maps of the sample image using the to-be-trained keypoint prediction model.

Here, the specific process of extracting the feature maps of the sample image using the to-be-trained keypoint prediction model can be referred to as step S102 in the above embodiment and will not be repeated here.

Step 206: The server determines the first predicted position information of the sample keypoints and the first predicted offset information of the target pixel regions where the sample keypoints are located in the feature maps.

The specific process of determining the first predicted position information of the sample keypoints and the first predicted offset information of the target pixel regions where the sample keypoints are located in the feature maps can be found in step S103 of the above embodiment and will not be repeated here.

Step 207: The server determines a model loss value based on the first sample position information, the first predicted position information, and the first sample offset information and the first predicted offset information of the sample keypoints in the target pixel regions.

The specific process of determining the model loss value based on the first sample position information, the first predicted position information, and the first sample offset information and the first predicted offset information of the sample keypoints in the target pixel regions can be found in step S104 of the above embodiment and will not be repeated here.

Step 208: The server updates the model parameters of the to-be-trained keypoint prediction model based on the model loss value, thereby obtaining a trained keypoint prediction model.

Here, based on the model loss value, the model parameters of the to-be-trained keypoint prediction model are updated. The specific process of obtaining the trained keypoint prediction model can be referred to step S105 in the above embodiment, and will not be repeated here.

The server calculates a more accurate model loss value based on the first sample position information, the first predicted position information, the first sample offset information, and the first predicted offset information. This model loss value is then used to train the keypoint prediction model, thereby improving the detection accuracy and stability of the keypoint prediction model.

The following describes an exemplary application of the present embodiment in a practical application scenario.

One embodiment of the present disclosure proposes a method for stable prediction of keypoints based on keypoint neighborhood constraints. This method is a method for predicting keypoints based on regression. The keypoint offset (self_offset) constraint and the neighboring keypoint offset (neighborhood_offset) constraint are added to the last feature map of the keypoint prediction model to assist in more accurate generation of keypoint positions. In the regression method, the regression loss (wingloss) is more capable of capturing small errors in keypoints, so the regression loss (wingloss) is used to train the keypoint prediction model. In addition, based on the regression loss (wingloss), the distance constraint of the neighboring keypoint (neighborhood) is introduced to guide the keypoint prediction model to learn global capabilities.

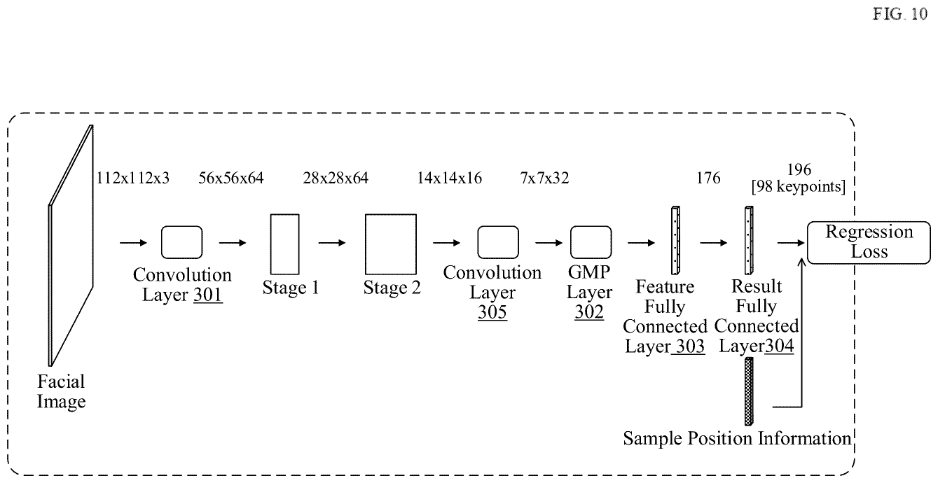

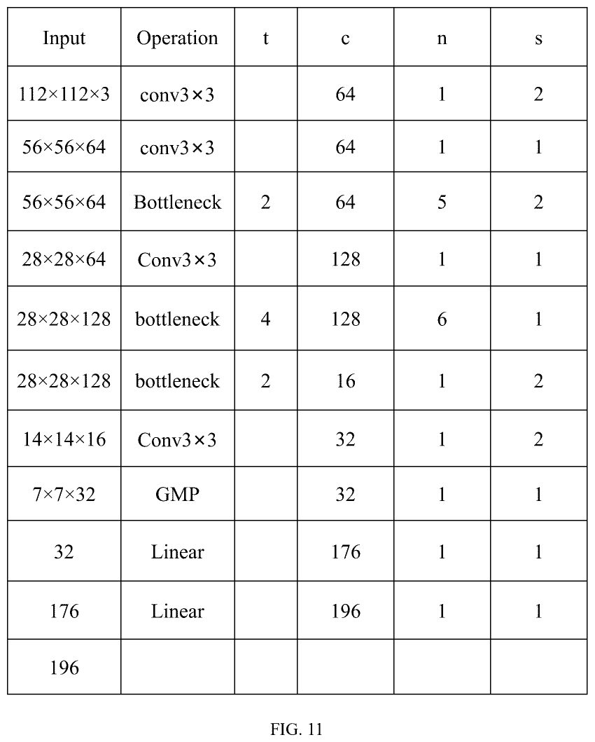

FIG. 10 is a schematic diagram of the basic model structure of a keypoint prediction model according to one embodiment. Referring to FIG. 10, the keypoint prediction model consists of multiple convolutional layers (i.e., convolutional layer 301 and convolutional layer 305), a global group max pooling (GMP) layer 302, and two fully connected layers (i.e., feature fully connected layer 303 and result fully connected layer 304). The global group max pooling layer is used to reduce the spatial dimension of the feature maps while retaining important features. Sample position information (ground-truth) refers to the coordinate data of the actual positions of the facial keypoints. A face has a total of 98 keypoints. FIG. 11 shows the operational flow of the keypoint prediction model.

As shown in FIG. 11, conv3×3 represents a convolution operation. The bottleneck layer consists of multiple convolutional layers. t represents the transpose factor within the bottleneck layer. t=2 indicates that the number of channels is first amplified to 64×2=128 and then reduced back to 64 at the output. Linear represents the mapping operation within the fully connected layers. c represents the number of channels in the convolution kernels, n represents the number of repetitions, and s represents the side length. First, a facial image of size 112×112×3 (width, height, and number of channels) is input. It is processed by the first convolutional layer 301 in FIG. 10 to produce a 56×56×64 feature map. This 56×56×64 feature map is then processed by stage 1 in FIG. 10 (stage 1 includes the bottleneck operation in FIG. 11) to produce a 28×28×64 feature map. After stage 2 processing and convolution processing, a 7×7×32 feature map is obtained, and the 7×7×32 feature map is input into the global group max pooling layer 302 to obtain a 32-bit feature vector. After the fully connected layers, 196 coordinate values are finally obtained, which corresponds to the first predicted position information in the above embodiments.

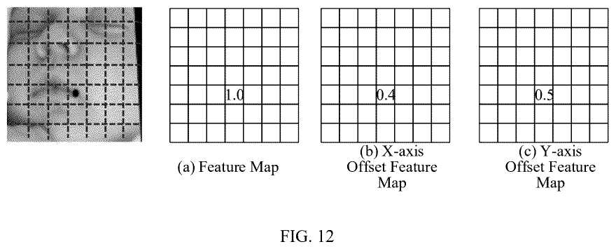

As shown in FIG. 4, during training, the 7×7×32 feature map is further convolved to produce a 7×7×98 feature map (corresponding to the feature map in the above embodiments), a 7×7×196 offset feature map, and a 7×7×1960 neighboring offset feature map. The 7×7×98 feature map is responsible for predicting 98 keypoints, meaning each channel predicts one keypoint. FIG. 12 is a schematic diagram of multiple feature maps according to one embodiment. (a) in FIG. 12 is a 7×7×98 feature map (score_map), which includes 7×7=49 pixel regions. It can be used to calculate whether a keypoint falls within a pixel region. If the value (corresponding to the first prediction score in the above embodiment) is 1 or close to 1, the keypoint falls within the pixel region. The 7×7×196 offset feature map is used to predict the x- and y-axis offsets of each keypoint (corresponding to the first predicted offset information in the above embodiments). (b) in FIG. 12 shows the offset feature map (x-offset_map) in the x-axis direction, which is 7×7×196. The x-axis offset of the keypoint is 0.4. Since the offset feature map is 7×7 and the original facial image is 112×112, there are 16 pixels in one pixel region in the feature map. Assuming the top left corner of the pixel region is (0, 0), 16×0.4-6.4, which is approximately 6 coordinate points offset to the right. (c) in FIG. 12 shows the offset feature map (y-offset_map) in the y-axis direction, which is 7×7×196. The y-axis offset is 0.4. The shift calculation is the same as above. The 7×7×1960 neighboring offset feature map is used to predict the offsets of the 10 nearest neighboring keypoints of the keypoint on the x-axis and y-axis (corresponding to the second predicted offset information in the above embodiments). For any keypoint, the 10 closest points are selected from the remaining 97 keypoints as neighboring keypoints. The neighboring keypoints are determined by the distances calculated from the real coordinate values. Since the neighboring keypoints are introduced in the prediction process, the predicted keypoints can be made more stable, which can better reduce false detections in the lip movement recognition speech scenario.

Let the loss of a feature map (score_map) be denoted as Lₛ (corresponding to the first loss value in the above embodiments), the loss of an offset feature map (self-offset_map) be denoted as L_{self-off} (corresponding to the fourth loss value in the above embodiments), and the loss of a neighboring offset feature map (neighborhood-offset_map) be denoted as L_{n-off} (corresponding to the fifth loss value in the above embodiment). The feature map loss Lₛ can satisfy the above equation (1). The offset feature map loss L_{self-off} can satisfy the above equation (2), and the neighboring offset feature map loss L_{n-off} can satisfy the above equation (3). The feature map loss Lₛ is calculated over the entire feature map, while the offset feature map loss L_{self-off} and the neighboring offset feature map loss L_{n-off} are only calculated when

$${s}_{ijk}^{gt} = 1 ,$$

that is, when the keypoint is actually located in the pixel region. In the equation, gt represents the groundtruth, pred represents the network prediction, and i represents the channel, corresponding to the index of the keypoints. The spatial guide loss (Spatial_guide_loss) can be obtained by weighted summing the feature map loss Lₛ, the offset feature map loss L_{self-off}, and the neighboring offset feature map loss L_{n-off}. The spatial guide loss can be calculated according to the following equation (7): L_{spatial_loss}=Lₛ+ω₁L_{self-off}+ω₂L_{n-off}, where L_{spatial_loss} is the spatial guide loss, and ω₁ and ω₂ are both hyperparameters (weight parameters).

To enable better learning of the constraint loss of the feature map, a distance constraint of neighboring keypoints is further introduced as an auxiliary constraint. As described earlier, 10 nearest neighboring keypoints are recorded for each keypoint, and the distances from the keypoint to its 10 neighboring keypoints are introduced as additional constraint terms. The distances can be calculated according to the following equation (8): Dist(P,N)=∥Pᵢ−P_{N}∥, where Dist(P,N) is the distance between keypoint P and its neighboring keypoint N, where Pᵢ is the i-th keypoint and P_{N} is the N-th neighboring keypoint of the i-th keypoint. The neighboring distance loss (corresponding to the sixth loss value in the above embodiments) can be calculated according to the above equation (4). The neighboring distance loss can help reduce the overall loss value by guiding the rapid learning of feature maps, thereby achieving a more accurate and stable effect. The total model loss value Lₜₒₜₐₗ can be calculated according to the following equation (9): Lₜₒₜₐₗ=wingloss+L_{spatial_loss}+L_{nb}, where L_{nb} is the neighboring distance loss, wingloss is the regression loss (corresponding to the seventh loss value in the above embodiments). The regression loss can satisfy the above equations (5) and (6).

A stable and accurate keypoint prediction model optimization strategy has been designed for edge platforms. This allows the keypoint algorithm to improve accuracy without increasing model complexity, significantly improving the accuracy of the model's keypoint predictions. Furthermore, the embodiments of the present disclosure can further provide insights for other fields. By using auxiliary information supervision, network learning can be made more targeted, resulting in higher accuracy and facilitating the implementation of lightweight models.

It should be noted that in the embodiments of the present disclosure, when data related to facial images is involved, when the embodiments of the present disclosure are applied to specific products or technologies, user permission or consent is required, and the collection, use and processing of relevant data must comply with relevant laws, regulations and standards.

The following continues to describe an exemplary structure of the keypoint prediction model training apparatus 455 according to one embodiment implemented as a software module. In one embodiment, as shown in FIG. 2, the software modules stored in the keypoint prediction model training device 455 in the storage 450 may include a sample acquisition module 4551, a feature map extraction module 4552, a prediction module 4553, a loss determination module 4554, and a model training module 4555.

The sample acquisition module 4551 is to obtain one or more sample keypoints in a sample image and first sample position information of the one or more sample keypoints. The feature map extraction module 4552 is to extract a number of feature maps of the sample image using a to-be-trained keypoint prediction model. The prediction module 4553 is to determine first predicted position information of the one or more sample keypoints, and first predicted offset information of one or more target pixel regions where the one or more sample keypoints are located in the feature maps. The loss determination module 4554 is to determine a model loss value based on the first sample position information, the first predicted position information, first sample offset information of the one or more target pixel regions where the one or more sample keypoints are located, and the first predicted offset information. The model training module 4555 is to update model parameters of the to-be-trained keypoint prediction model based on the model loss value to obtain a trained keypoint prediction model.

In one embodiment, the loss determination module 4554 is further to: determine a first loss value for the to-be-trained keypoint prediction model based on the first sample position information; determine one or more sample neighboring keypoints of the one or more sample keypoints based on the first sample position information; determine a second loss value for the to-be-trained keypoint prediction model based on the first sample offset information, the first predicted offset information, second sample offset information of the one or more sample neighboring keypoints in the one or more target pixel regions, and the second predicted offset information of the one or more sample neighboring keypoints in the one or more target pixel regions; determine a third loss value for the to-be-trained keypoint prediction model based on the first sample position information, the first predicted position information, second sample position information of the one or more sample neighboring keypoints, and second predicted position information of the one or more sample neighboring keypoints; and determine the model loss value based on the first loss value, the second loss value, and the third loss value.

In one embodiment, the loss determination module 4554 is further to: based on the first sample position information, determine a first label score for each of the one or more sample keypoints with respect to each of a number of pixel regions in a corresponding one of the feature maps; perform feature mapping on the feature maps to obtain a number of first prediction scores for each of the one or more sample keypoints with respect to each of a plurality of pixel regions in a corresponding one of the feature maps; and perform feature map loss calculation based on the first prediction scores and the first label scores to obtain the first loss value.

In one embodiment, the loss determination module 4554 is further to: based on the first sample location information, for each of the one or more sample keypoints, determine the first label score to be a first preset score in response to the sample keypoint being within one of the pixel regions in the corresponding one of the feature maps, and determine the first label score to be a second preset score in response to the sample keypoint being outside the one of the plurality of pixel regions in the corresponding one of the feature maps.

In one embodiment, the loss determination module 4554 is further to: perform first offset loss calculation based on the first predicted offset information and the first sample offset information to obtain a fourth loss value; perform second offset loss calculation based on the second predicted offset information and the second sample offset information to obtain a fifth loss value; and perform loss value fusion based on the fourth loss value and the fifth loss value to obtain the second loss value.

In one embodiment, the loss determination module 4554 is further to: based on the first predicted position information and the second predicted position information, determine a first predicted distance between each of the one or more sample keypoints and each of the one or more sample neighboring keypoints; based on the first sample position information and the second sample position information, determine a first sample distance between each of the one or more sample keypoints and each of the one or more sample neighboring keypoints; perform distance loss calculation based on the first predicted distances and the first sample distances to obtain a sixth loss value; perform position loss calculation based on the first sample position information and the first predicted position information to obtain a seventh loss value; and perform loss value fusion based on the sixth loss value and the seventh loss value to obtain the third loss value.

In one embodiment, the loss determination module 4554 is further to: determine a position information error between the first sample position information and the first predicted position information; and in response to the position information error being less than a preset position error, determine a first parameter based on a preset parameter and the position information error, and determining a product of the preset position error and the first parameter as the seventh loss value for the one or more sample keypoints.

In one embodiment, the loss determination module 4554 is further to: determine a position information error between the first sample position information and the first predicted position information; in response to the position information error being greater than or equal to a preset position error, determine a second parameter based on a preset parameter and the position information error, and determining a product of the preset position error and the second parameter; determine a difference between the preset position error and the product as a first difference; and determine a second difference between the position error and the first difference as the seventh loss value.

The present disclosure further provides a computer program product including a computer program or computer-executable instructions stored in a computer-readable storage medium. A processor of an electronic device reads the computer-executable instructions from the computer-readable storage medium and executes the computer-executable instructions, causing the electronic device to perform the keypoint prediction model training method described in the above embodiments.

Another aspect of the present disclosure is directed to a non-transitory computer-readable medium storing instructions which, when executed, cause one or more processors to perform the methods, as discussed above, for example, the keypoint prediction model training method shown in FIG. 3. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In one embodiment, the computer-readable medium may be a disc or a flash drive having the computer instructions stored thereon.

In some embodiments, computer-executable instructions may take the form of a program, software, software module, script, or code, written in any programming language (including compiled or interpreted languages, or declarative or procedural languages), and may be deployed in any form, including as a standalone program or as a module, component, subroutine, or other unit suitable for use in a computing environment.

By way of example, the computer-executable instructions may, but need not necessarily, correspond to a file in a file system, may be stored as part of a file storing other programs or data, such as one or more scripts in a Hypertext Markup Language (HTML) document, in a single file dedicated to the program under discussion, or in multiple coordinated files (e.g., files storing one or more modules, subroutines, or portions of code).

By way of example, the computer-executable instructions may be deployed for execution on a single electronic device, on multiple electronic devices located at a single site, or on multiple electronic devices distributed across multiple sites and interconnected by a communication network.

In summary, a stable and accurate keypoint prediction model optimization strategy has been designed for edge platforms. This allows the keypoint algorithm to improve accuracy without increasing model complexity, significantly improving the accuracy of the model's keypoint predictions. Furthermore, the embodiments of the present disclosure can further provide insights for other fields. By using auxiliary information supervision, network learning can be made more targeted, resulting in higher accuracy and facilitating the implementation of lightweight models.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented keypoint prediction model training method, the method comprising:
obtaining one or more sample keypoints in a sample image and first sample position information of the one or more sample keypoints;
extracting a plurality of feature maps of the sample image using a to-be-trained keypoint prediction model;
determining first predicted position information of the one or more sample keypoints, and first predicted offset information of one or more target pixel regions where the one or more sample keypoints are located in the plurality of feature maps;
determining a model loss value based on the first sample position information, the first predicted position information, first sample offset information of the one or more target pixel regions where the one or more sample keypoints are located, and the first predicted offset information; and
updating model parameters of the to-be-trained keypoint prediction model based on the model loss value to obtain a trained keypoint prediction model.

2. The method of claim 1, wherein determining the model loss value comprises:
determining a first loss value for the to-be-trained keypoint prediction model based on the first sample position information;
determining one or more sample neighboring keypoints of the one or more sample keypoints based on the first sample position information;
determining a second loss value for the to-be-trained keypoint prediction model based on the first sample offset information, the first predicted offset information, second sample offset information of the one or more sample neighboring keypoints in the one or more target pixel regions, and the second predicted offset information of the one or more sample neighboring keypoints in the one or more target pixel regions;
determining a third loss value for the to-be-trained keypoint prediction model based on the first sample position information, the first predicted position information, second sample position information of the one or more sample neighboring keypoints, and second predicted position information of the one or more sample neighboring keypoints; and
determining the model loss value based on the first loss value, the second loss value, and the third loss value.

3. The method of claim 2, wherein determining the first loss value for the to-be-trained keypoint prediction model based on the first sample position information comprises:
based on the first sample position information, determining a first label score for each of the one or more sample keypoints with respect to each of a plurality of pixel regions in a corresponding one of the feature maps;
performing feature mapping on the feature maps to obtain a plurality of first prediction scores for each of the one or more sample keypoints with respect to each of a plurality of pixel regions in a corresponding one of the feature maps; and
performing feature map loss calculation based on the first prediction scores and the first label scores to obtain the first loss value.

4. The method of claim 3, wherein determining the first label score for each of the one or more sample keypoints with respect to each of a plurality of pixel regions in a corresponding one of the feature maps comprises:
based on the first sample location information, for each of the one or more sample keypoints, determining the first label score to be a first preset score in response to the sample keypoint being within one of the plurality of pixel regions in the corresponding one of the feature maps, and determining the first label score to be a second preset score in response to the sample keypoint being outside the one of the plurality of pixel regions in the corresponding one of the feature maps.

5. The method of claim 2, wherein determining the second loss value for the to-be-trained keypoint prediction model comprises:
performing first offset loss calculation based on the first predicted offset information and the first sample offset information to obtain a fourth loss value;
performing second offset loss calculation based on the second predicted offset information and the second sample offset information to obtain a fifth loss value; and
performing loss value fusion based on the fourth loss value and the fifth loss value to obtain the second loss value.

6. The method of claim 2, wherein determining the third loss value for the to-be-trained keypoint prediction model comprises:
based on the first predicted position information and the second predicted position information, determining a first predicted distance between each of the one or more sample keypoints and each of the one or more sample neighboring keypoints;
based on the first sample position information and the second sample position information, determining a first sample distance between each of the one or more sample keypoints and each of the one or more sample neighboring keypoints;
performing distance loss calculation based on the first predicted distances and the first sample distances to obtain a sixth loss value;
performing position loss calculation based on the first sample position information and the first predicted position information to obtain a seventh loss value; and
performing loss value fusion based on the sixth loss value and the seventh loss value to obtain the third loss value.

7. The method of claim 6, wherein performing position loss calculation based on the first sample position information and the first predicted position information to obtain the seventh loss value comprises:
determining a position information error between the first sample position information and the first predicted position information; and
in response to the position information error being less than a preset position error, determining a first parameter based on a preset parameter and the position information error, and determining a product of the preset position error and the first parameter as the seventh loss value for the one or more sample keypoints.

8. The method of claim 6, wherein performing position loss calculation based on the first sample position information and the first predicted position information to obtain the seventh loss value comprises:
determining a position information error between the first sample position information and the first predicted position information;
in response to the position information error being greater than or equal to a preset position error, determining a second parameter based on a preset parameter and the position information error, and determining a product of the preset position error and the second parameter;
determining a difference between the preset position error and the product as a first difference; and
determining a second difference between the position error and the first difference as the seventh loss value.

9. An electronic device comprising:
one or more processors; and
a memory coupled to the one or more processors, the memory storing programs that, when executed by the one or more processors, cause performance of operations comprising:
obtaining one or more sample keypoints in a sample image and first sample position information of the one or more sample keypoints;
extracting a plurality of feature maps of the sample image using a to-be-trained keypoint prediction model;
determining first predicted position information of the one or more sample keypoints, and first predicted offset information of one or more target pixel regions where the one or more sample keypoints are located in the plurality of feature maps;
determining a model loss value based on the first sample position information, the first predicted position information, first sample offset information of the one or more target pixel regions where the one or more sample keypoints are located, and the first predicted offset information; and
updating model parameters of the to-be-trained keypoint prediction model based on the model loss value to obtain a trained keypoint prediction model.

10. The electronic device of claim 9, wherein determining the model loss value comprises:
determining a first loss value for the to-be-trained keypoint prediction model based on the first sample position information;
determining one or more sample neighboring keypoints of the one or more sample keypoints based on the first sample position information;
determining a second loss value for the to-be-trained keypoint prediction model based on the first sample offset information, the first predicted offset information, second sample offset information of the one or more sample neighboring keypoints in the one or more target pixel regions, and the second predicted offset information of the one or more sample neighboring keypoints in the one or more target pixel regions;
determining a third loss value for the to-be-trained keypoint prediction model based on the first sample position information, the first predicted position information, second sample position information of the one or more sample neighboring keypoints, and second predicted position information of the one or more sample neighboring keypoints; and
determining the model loss value based on the first loss value, the second loss value, and the third loss value.

11. The electronic device of claim 10, wherein determining the first loss value for the to-be-trained keypoint prediction model based on the first sample position information comprises:
based on the first sample position information, determining a first label score for each of the one or more sample keypoints with respect to each of a plurality of pixel regions in a corresponding one of the feature maps;
performing feature mapping on the feature maps to obtain a plurality of first prediction scores for each of the one or more sample keypoints with respect to each of a plurality of pixel regions in a corresponding one of the feature maps; and
performing feature map loss calculation based on the first prediction scores and the first label scores to obtain the first loss value.

12. The electronic device of claim 11, wherein determining the first label score for each of the one or more sample keypoints with respect to each of a plurality of pixel regions in a corresponding one of the feature maps comprises:
based on the first sample location information, for each of the one or more sample keypoints, determining the first label score to be a first preset score in response to the sample keypoint being within one of the plurality of pixel regions in the corresponding one of the feature maps, and determining the first label score to be a second preset score in response to the sample keypoint being outside the one of the plurality of pixel regions in the corresponding one of the feature maps.

13. The electronic device of claim 10, wherein determining the second loss value for the to-be-trained keypoint prediction model comprises:
performing first offset loss calculation based on the first predicted offset information and the first sample offset information to obtain a fourth loss value;
performing second offset loss calculation based on the second predicted offset information and the second sample offset information to obtain a fifth loss value; and
performing loss value fusion based on the fourth loss value and the fifth loss value to obtain the second loss value.

14. The electronic device of claim 10, wherein determining the third loss value for the to-be-trained keypoint prediction model comprises:
based on the first predicted position information and the second predicted position information, determining a first predicted distance between each of the one or more sample keypoints and each of the one or more sample neighboring keypoints;
based on the first sample position information and the second sample position information, determining a first sample distance between each of the one or more sample keypoints and each of the one or more sample neighboring keypoints;
performing distance loss calculation based on the first predicted distances and the first sample distances to obtain a sixth loss value;
performing position loss calculation based on the first sample position information and the first predicted position information to obtain a seventh loss value; and
performing loss value fusion based on the sixth loss value and the seventh loss value to obtain the third loss value.

15. The electronic device of claim 14, wherein performing position loss calculation based on the first sample position information and the first predicted position information to obtain the seventh loss value comprises:
determining a position information error between the first sample position information and the first predicted position information; and
in response to the position information error being less than a preset position error, determining a first parameter based on a preset parameter and the position information error, and determining a product of the preset position error and the first parameter as the seventh loss value for the one or more sample keypoints.

16. The electronic device of claim 14, wherein performing position loss calculation based on the first sample position information and the first predicted position information to obtain the seventh loss value comprises:
determining a position information error between the first sample position information and the first predicted position information;
in response to the position information error being greater than or equal to a preset position error, determining a second parameter based on a preset parameter and the position information error, and determining a product of the preset position error and the second parameter;
determining a difference between the preset position error and the product as a first difference; and
determining a second difference between the position error and the first difference as the seventh loss value.

17. A non-transitory computer-readable storage medium storing instructions that, when executed by at least one processor of an electronic device, cause the at least one processor to perform a keypoint prediction model training method, the method comprising:
obtaining one or more sample keypoints in a sample image and first sample position information of the one or more sample keypoints;
extracting a plurality of feature maps of the sample image using a to-be-trained keypoint prediction model;
determining first predicted position information of the one or more sample keypoints, and first predicted offset information of one or more target pixel regions where the one or more sample keypoints are located in the plurality of feature maps;
determining a model loss value based on the first sample position information, the first predicted position information, first sample offset information of the one or more target pixel regions where the one or more sample keypoints are located, and the first predicted offset information; and
updating model parameters of the to-be-trained keypoint prediction model based on the model loss value to obtain a trained keypoint prediction model.

18. The non-transitory computer-readable storage medium of claim 17, wherein determining the model loss value comprises:
determining a first loss value for the to-be-trained keypoint prediction model based on the first sample position information;
determining one or more sample neighboring keypoints of the one or more sample keypoints based on the first sample position information;
determining a second loss value for the to-be-trained keypoint prediction model based on the first sample offset information, the first predicted offset information, second sample offset information of the one or more sample neighboring keypoints in the one or more target pixel regions, and the second predicted offset information of the one or more sample neighboring keypoints in the one or more target pixel regions;
determining a third loss value for the to-be-trained keypoint prediction model based on the first sample position information, the first predicted position information, second sample position information of the one or more sample neighboring keypoints, and second predicted position information of the one or more sample neighboring keypoints; and
determining the model loss value based on the first loss value, the second loss value, and the third loss value.

19. The non-transitory computer-readable storage medium of claim 18, wherein determining the first loss value for the to-be-trained keypoint prediction model based on the first sample position information comprises:
based on the first sample position information, determining a first label score for each of the one or more sample keypoints with respect to each of a plurality of pixel regions in a corresponding one of the feature maps;
performing feature mapping on the feature maps to obtain a plurality of first prediction scores for each of the one or more sample keypoints with respect to each of a plurality of pixel regions in a corresponding one of the feature maps; and
performing feature map loss calculation based on the first prediction scores and the first label scores to obtain the first loss value.

20. The non-transitory computer-readable storage medium of claim 19, wherein determining the first label score for each of the one or more sample keypoints with respect to each of a plurality of pixel regions in a corresponding one of the feature maps comprises:
based on the first sample location information, for each of the one or more sample keypoints, determining the first label score to be a first preset score in response to the sample keypoint being within one of the plurality of pixel regions in the corresponding one of the feature maps, and determining the first label score to be a second preset score in response to the sample keypoint being outside the one of the plurality of pixel regions in the corresponding one of the feature maps.
